(19) United States
(12) Patent Application Publication
(10) Pub. No.: US 2008/0151165 A1
(43) Pub. Date: Jun. 26, 2008

(54) OPTICAL LAMINATE AND LIQUID CRYSTAL PANEL USING THE SAME

(75) Inventor: Hiroyuki TAKEMOTO, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Osaka (JP)

(21) Appl. No.: 11/964,374

(22) Filed: Dec. 26, 2007

(30) Foreign Application Priority Data
Dec. 26, 2006 (JP) 2006-349820

(51) Int. Cl. G02F 1/13363; G02B 5/30

(52) U.S. Cl. 349/118; 359/499

(57) ABSTRACT

The optical laminate according to an embodiment of the present invention includes a first retardation layer having a refractive index profile of nx>ny=nz, a second retardation layer having a refractive index profile of nz>nx=ny, and an adhesion enhancement layer containing polyethyleneimine as a main component in the state order.

This application claims priority under 35 U.S.C. Section 119 to Japanese Patent Application No. 2006-349820 filed on Dec. 26, 2006, which is herein incorporated by references.

### BACKGROUND OF THE INVENTION

1. Field of the Invention

The present invention relates to an optical laminate and a liquid crystal panel.

2. Description of Related Art

Recently, in an image display apparatus such as a liquid crystal display apparatus, various optical elements have been used so as to enhance display quality. For example, a retardation film is used for the purpose of preventing coloring and enlarging a viewing angle.

The retardation film is generally laminated on a polarizing plate, another retardation film, a brightness enhancing film, or the like, and attached to a liquid crystal cell using a pressure-sensitive adhesive. In this case, there is an advantage in that a drying step is not required for fixing the retardation film, so a pressure-sensitive type retardation film in which a pressure-sensitive adhesive is previously provided on one surface of a retardation layer as a pressure-sensitive adhesive layer is generally used.

One example of such a retardation film is a positive C plate having a refractive index profile of nz>nx=ny. In order to enhance durability, the alignment property of the positive C plate is generally fixed by three-dimensional cross-linking caused by UV irradiation after application of a solution of a liquid crystal composition. However, the positive C plate still has a problem in terms of durability because its retardation value changes under high temperature and high humidity. Further, in the case where the positive C plate is placed adjacent to a pressure-sensitive adhesive layer, the adhesive strength (anchoring force) between the positive C plate and the pressure-sensitive adhesive layer is insufficient (for example, see JP 2006-189781 A).

### SUMMARY OF THE INVENTION

The present invention has been made in view of solving the above-mentioned problems, and an object of the present invention is therefore to provide an optical laminate and a liquid crystal panel in which change in the retardation value of a retardation layer having a refractive index profile of nz>nx=ny is small under high temperature and high humidity, and which is excellent in the adhesive strength (anchoring force) between the retardation layer and the pressure-sensitive adhesive layer.

The optical laminate according to an embodiment of the present invention includes a first retardation layer having a refractive index profile of nx>ny=nz, a second retardation layer having a refractive index profile of nz>nx=ny, and an adhesion enhancement layer containing polyethyleneimine as a main component in the state order.

In a preferred embodiment of the present invention, the first retardation layer functions as a base material.

In a preferred embodiment of the present invention, the first retardation layer comprises a stretched film of a polymer film containing polynorbornene as a main component.

In a preferred embodiment of the present invention, the first retardation layer comprises a stretched film of a polymer film containing polycarbonate as a main component.

In a preferred embodiment of the present invention, the first retardation layer has an in-plane retardation value (Re[590]) of 50 nm to 180 nm measured with light having a wavelength of 590 nm at 23° C.

In a preferred embodiment of the present invention, the first retardation layer has a thickness of 10 μm to 500 μm.

In a preferred embodiment of the present invention, the second retardation layer is placed on the first retardation layer via an adhesive layer.

In a preferred embodiment of the present invention, the second retardation layer is directly placed on the first retardation layer.

In a preferred embodiment of the present invention, the second retardation layer has a thickness direction retardation value (Rth[590]) of −200 nm to −30 nm measured with light having a wavelength of 590 nm at 23° C.

In a preferred embodiment of the present invention, the second retardation layer comprises one of a solidified layer and a cured layer of a liquid crystal composition aligned homeotropically.

In a preferred embodiment of the present invention, the content of a liquid crystal compound in the liquid crystal composition is 40 to 100 (weight ratio) with respect to a total solid content of 100.

In a preferred embodiment of the present invention, the adhesion enhancement layer has a thickness of 1 μm to 30 μm.

In a preferred embodiment of the present invention, the polyethyleneimine has a weight average molecular weight of 100 to 1,000,000.

In a preferred embodiment of the present invention, the polyethyleneimine has a primary amino group at a terminal.

In a preferred embodiment of the present invention, the optical laminate further includes a pressure-sensitive adhesive layer on the side of the adhesion enhancement layer on which the second retardation layer is not provided.

In a preferred embodiment of the present invention, the optical laminate further includes a polarizer on the side of the first retardation layer on which the second retardation layer is not provided.

According to another aspect of the present invention, a liquid crystal panel is provided. The liquid crystal panel of the present invention includes a liquid crystal cell and the optical laminate of the present invention.

According to the present invention, by providing an adhesion enhancement layer containing polyethyleneimine as a main component between the retardation layer (so-called positive C plate) having a refractive index profile of nz>nx=ny and the pressure-sensitive adhesive layer, the change in the retardation value of the positive C plate under high temperature and high humidity can be suppressed. It is considered that a solvent component and an acidic component extracted from a pressure-sensitive adhesive permeate the positive C plate under high temperature and high humidity, thereby changing the retardation value of the positive C plate. According to the present invention, it is considered that an imine bond contained in polyethyleneimine in the adhesion enhancement layer catches the above extract, thereby suppressing the change in the retardation value of the positive C plate. Further, according to the present invention, the adhesive strength (anchoring force) between the positive C plate and the pressure-sensitive adhesive layer can be enhanced.

### BRIEF DESCRIPTION OF THE DRAWINGS

In the accompanying drawings:

FIGS. 1A and 1B are schematic cross-sectional views of optical laminates according to a preferred embodiment of the present invention; and

FIG. 2 is a schematic cross-sectional view of a liquid crystal panel according to a preferred embodiment of the present invention.

### DETAILED DESCRIPTION OF THE PREFERRED EMBODIMENTS

### A. Entire Configuration of Optical Laminate

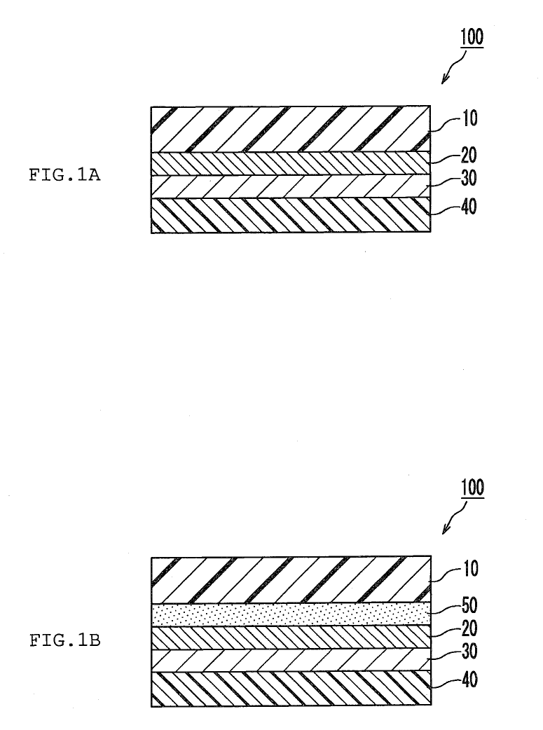

FIG. 1A is a schematic cross-sectional view of an optical laminate according to a preferred embodiment of the present invention. As shown in FIG. 1A, an optical laminate 100 includes a first retardation layer 10 having a refractive index profile of nx>ny=nz, a second retardation layer 20 having a refractive index profile of nz>nx=ny, and an adhesion enhancement layer 30 containing polyethyleneimine as a main component in the stated order. If required, the optical laminate of the present invention further includes a pressure-sensitive adhesive layer 40 on the side of the adhesion enhancement layer 30 on which the second retardation layer 20 is not provided. Further, in one embodiment, the optical laminate of the present invention may have a polarizer (not shown) on the side of the first retardation layer 10 on which the second retardation layer 20 is not provided.

In the optical laminate of the present invention, the second retardation layer 20 may be directly placed on the first retardation layer 10 (i.e., without the adhesive layer) as shown in FIG. 1A, or may be placed on the first retardation layer 10 via an adhesive layer 50 as shown in FIG. 1B.

### B. First Retardation Layer

The first retardation layer is a positive uniaxial optical element (so-called positive A plate) whose refractive index profile satisfies nx>ny=nz, where nx (slow axis direction) and ny (fast axis direction) are main refractive indices in a plane, and nz is a refractive index in a thickness direction. In the specification of the present invention, “ny=nz” includes not only the case where ny and nz are completely the same, but also the case where ny and nz are substantially the same. Herein, “the case where ny and nz are substantially the same” includes, for example, the case where a Nz coefficient (Rth[590]/Re[590]) has a relationship of 1<Nz<1.5. The slow axis direction refers to a direction in which a refractive index becomes maximum in a plane, and the fast axis direction refers to a direction perpendicular to the slow axis direction in the same plane.

In the specification of the present invention, Re[590] refers to an in-plane retardation value measured with light having a wavelength of 590 nm at 23° C. Re[590] can be obtained by an expression: Re[590]=(nx−ny)×d. Further, Rth[590] refers to a thickness direction retardation value measured with light having a wavelength of 590 nm at 23° C. Rth[590] can be obtained by an expression: Rth[590]=(nx−nz)×d, where d is a thickness (nm) of an optical element (or a retardation film).

Re[590] of the first retardation layer is preferably 50 nm to 180 nm, more preferably 80 nm to 160 nm, particularly preferably 80 nm to 150 nm, and most preferably 100 nm to 130 nm. By setting the above Re[590] in the above range, a contrast ratio in an oblique direction of a liquid crystal display apparatus can be enhanced in the case where the optical laminate of the present invention is used in the liquid crystal display apparatus.

An absolute value |Rth[590]−Re[590]| of the difference between Re[590] and Rth[590] of the first retardation layer is preferably 0 nm to 5 nm, and more preferably 0 nm to 2 nm. By setting the absolute value in the above range, a contrast ratio in an oblique direction of a liquid crystal display apparatus can be enhanced in the case where the optical laminate of the present invention is used in the liquid crystal display apparatus.

The thickness of the first retardation layer is preferably 10 μm to 500 μm, more preferably 20 μm to 400 μm, and most preferably 30 μm to 300 μm. When the first retardation layer has a thickness in such a range, a liquid crystal display apparatus having excellent optical uniformity can be obtained. Further, such a first retardation layer can function satisfactorily as a base material (support) of the optical laminate.

The first retardation layer used in the present invention is typically a stretched film (retardation film) of a polymer film containing a thermoplastic resin as a main component. Examples of the thermoplastic resin include general-purpose plastic such as polyethylene, polypropylene, polynorbornene, polyvinyl chloride, cellulose ester, polystyrene, ABS resin, AS resin, methyl polymethacrylate, polyvinyl acetate, and polyvinylidene chloride; general-purpose engineering plastic such as polyamide, polyacetal, polycarbonate, denatured polyphenylene ether, polybutyleneterephthalate, and polyethyleneterephthalate; and super-engineering plastic such as polyphenylene sulfide, polysulfon, polyethersulfon, polyether ether ketone, polyarylate, liquid crystal polymer, polyamideimide, polyimide, and polytetra fluoroethylene. The thermoplastic resin may be used alone or in combination. Preferably, the thermoplastic resin is a cycloolefin-based resin such as polynorbornene, or a polycarbonate for the reasons that they are excellent in transparency, mechanical strength, heat stability, a moisture shielding property, and the like, and are excellent in the ability of exhibiting a retardation value, the easiness of control of a retardation value, the adhesive property with respect to a polarizer, and the like. Thus, a stretched film containing the preferred thermoplastic resin as a main component can function as a base material (support) of the optical laminate.

The polynorbornene refers to a (co) polymer obtained by using a norbornene-based monomer having a norbornene ring in a part or an entirety of a starting material (monomer). Examples of the norbornene-based monomer include norbornene, and alkyl and/or alkylidene substituent thereof (e.g., 5-methyl-2-norbornene, 5-dimethyl-2-norbornene, 5-ethyl-2-norbornene, 5-butyl-2-norbornene, and 5-ethylidene-2-norbornene), and a substituent thereof with a polar group such as halogen; dicyclopentadiene, 2,3-dihydrodicyclopentadiene, etc.; and dimethanooctahydronaphthalene, alkyl and/or alkylidene substituent thereof, and a substituent thereof with a polar group such as halogen, a trimer and tetramer of cyclopentadiene (e.g., 4,9:5,8-dimethano-3a,4,4a,5,8,8a,9,9a-octa hydro-1H-benzoindene, 4,11:5,10:6,9-trimethano-3a,4,4a,5,5a,6,9,9a,10,10a,11,11a-dodecahydro-1H-cyclopentaanthracene).

Regarding the weight average molecular weight (Mw) of the polynorbornene, a value determined by a gel permeation chromatograph (GPC) method with a toluene solvent is preferably 20,000 to 400,000, more preferably 30,000 to 300,000, particularly preferably 40,000 to 200,000, and most preferably 40,000 to 80,000. In the case where the weight average molecular weight is in the above range, a resin being excellent in mechanical strength and having satisfactory solubility, forming property, and casting workability can be obtained.

As the polycarbonate, an aromatic polycarbonate containing an aromatic bivalent phenol component and a carbonate component is preferably used. The aromatic polycarbonate may be generally obtained through a reaction of an aromatic bivalent phenol compound and a carbonate precursor. That is, the aromatic polycarbonate may be obtained through: a phosgen method involving blowing phosgen into an aromatic bivalent phenol compound in the presence of caustic alkali and a solvent; or an ester exchange method involving performing ester exchange between an aromatic bivalent phenol compound and bisaryl carbonate in the presence of a catalyst.

Specific examples of the aromatic bivalent phenol compound include: 2,2-bis(4-hydroxyphenyl)propane; 9,9-bis(4-hydroxyphenyl)fluorene; 4,4′-biphenol; 4,4′-dihydroxybiphenylether, 2,2-bis(3-methyl-4-hydroxyphenyl)propane; 2,2-bis(3-bromo-4-hydroxyphenyl)propane; 2,2-bis(4-hydroxy-3,5-dimethylphenyl)propane; bis(4-hydroxyphenyl)methane; 1,1-bis(4-hydroxyphenyl)ethane; 2,2-bis(4-hydroxyphenyl)butane; 2,2-bis(4-hydroxy-3,5-dimethylphenyl)butane; 2,2-bis(4-hydroxy-3,5-dipropylphenyl)propane; 1,1-bis(4-hydroxyphenyl)cyclohexane; and 1,1-bis(4-hydroxyphenyl)-3,3,5-trimethylcyclohexane. They may be used alone or in combination.

Examples of the carbonate precursor include phosgene, bischloroformates of the above bivalent phenols, diphenyl carbonate, di-p-tolylcarbonate, phenyl-p-tolylcarbonate, di-p-chlorophenyl carbonate, and dinaphthyl carbonate. Of those, phosgene and diphenyl carbonate are preferred.

The polycarbonate has a weight average molecular weight (Mw) of preferably 25,000 to 250,000, more preferably 30,000 to 200,000, and particularly preferably 40,000 to 100,000 determined by gel permeation chromatography (GPC) method with a tetra hydrofuran solvent. In the case where the weight average molecular weight is in the above range, a resin being excellent in mechanical strength and having satisfactory solubility, forming property, and casting workability can be obtained.

As a method of forming a stretched film of a polymer film containing the above thermoplastic resin as a main component, any suitable stretching method can be adopted. Specific examples of the method include a longitudinal uniaxial stretching method, a transverse uniaxial stretching method, a longitudinal and transverse simultaneous biaxial stretching method, a longitudinal and transverse sequential biaxial stretching method, and the like. As stretching means, any suitable stretching machine such as a roll stretching machine, a tenter stretching machine, or a biaxial stretching machine can be used.

The temperature (stretching temperature) for stretching the polymer film is preferably a glass transition temperature (Tg) of the polymer film or higher. This is because a retardation value is likely to become uniform in a width direction, and further, a film is unlikely to be crystallized (cloudy). The stretching temperature is preferably Tg+1° C. to Tg+30° C. More specifically, the stretching temperature is preferably 110° C. to 200° C., and more preferably 120° C. to 180° C.

The stretching ratio for stretching the polymer film can be appropriately set depending upon the composition of the polymer film, the kinds of a volatile component and the like, the remaining amount of a volatile component and the like, the retardation value to be designed, etc. The stretching ratio is, for example, 1.05 to 2.00 times.

Further, as the retardation film used in the first retardation layer, a commercially available optical film can also be used as it is. Further, a commercially available optical film subjected to a fabrication such as a stretching treatment and/or a relaxation treatment may be used. Specific examples of a commercially available polynorbornene film include “ZEONEX series” (480, 480R, etc.) (trade name) manufactured by Zeon Corporation, “Zeonor series” (ZF14, ZF16, etc.) (trade name) manufactured by Zeon Corporation, and “Arton series” (ARTON G, ARTON F, etc.) (trade name) manufactured by JSR Corporation. Further, specific examples of a commercially available polycarbonate film include “Pureace series” (trade name) manufactured by Teijin Chemicals Ltd., “Elmech series” (R140, R435, etc.) manufactured by Kaneka Corporation), and “Illuminex series” manufactured by GE Plastics Japan Ltd.

### C. Second Retardation Layer

The second retardation layer is a positive uniaxial optical element (so-called positive C plate) whose refractive index profile satisfies nz>nx=ny, where nx (slow axis direction) and ny (fast axis direction) are main refractive indices in a plane, and nz is a refractive index in a thickness direction. In the specification of the present invention, “nx=ny” includes not only the case where nx and ny are completely the same, but also the case where nx and ny are substantially the same. Herein, “the case where nx and ny are substantially the same” includes, for example, the case where an in-plane retardation value (Re[590]) is 10 nm or less.

Re[590] of the second retardation layer is preferably 0 nm to 5 nm, and more preferably 0 nm to 2 nm. By setting Re[590] in the above range, a contrast ratio in an oblique direction of a liquid crystal display apparatus can be enhanced in the case where the optical laminate of the present invention is used in the liquid crystal display apparatus.

Rth[590] of the second retardation layer is preferably −200 nm to −30 nm, more preferably −180 nm to −40 nm, particularly preferably −160 nm to −50 nm, and most preferably −130 nm to −70 nm. By setting Rth[590] in the above range, a contrast ratio in an oblique direction of the liquid crystal display apparatus can be enhanced in the case where the optical laminate of the present invention is used in the liquid crystal display apparatus.

The second retardation layer is preferably a solidified layer or a cured layer of a liquid crystal composition aligned homeotropically. In the specification of the present invention, a “homeotropic alignment” refers to a state in which a liquid crystal compound contained in a liquid crystal composition is aligned in parallel and uniformly with respect to a film normal line. Further, the term “solidified layer” refers to a layer which is obtained by cooling a softened or molten liquid crystal composition or a liquid crystal composition in a solution state into a solidified state. The term “cured layer” refers to a layer which is obtained by cross-linking the liquid crystal composition by heat, a catalyst, light, and/or radiation into a stable insoluble and non-melted state or a stable hardly soluble and hardly melted state. Note that the “cured layer” includes a cured layer obtained from a solidified layer of a liquid crystal composition.

In the specification of the present invention, the term “liquid crystal composition” refers to a composition having a liquid crystal phase and exhibiting liquid crystallinity. Examples of the liquid crystal phase include a nematic liquid crystal phase, a smectic liquid crystal phase, and a cholesteric liquid crystal phase. The liquid crystal composition to be used in the present invention is preferably a liquid crystal composition exhibiting a nematic liquid crystal phase for attaining a retardation film having high transparency. The liquid crystal phase is generally developed with a liquid crystal compounds having a mesogenic group formed of a ring unit and the like in the molecular structure.

A content of the liquid crystal compound in the liquid crystal composition is preferably 40 to 100 (by weight), more preferably 50 to 99 (by weight), and particularly preferably 70 to 98 parts (by weight) with respect to 100 of a total solid content. The liquid crystal composition may contain various additives such as a leveling agent, a polymerization initiator, an alignment agent, a heat stabilizer, a lubricant, a plasticizer, and an antistatic agent within a range not inhibiting the object of the present invention.

As the mesogenic group formed of ring units, etc., in the liquid crystal compound include a biphenyl group, a phenylbenzoate group, a phenylcyclohexane group, an azoxybenzene group, an azomethine group, an azobenzene group, a phenylpyrimidine group, a diphenylacetylene group, a diphenylbenzoate group, a bicyclohexane group, a cyclohexylbenzene group, and a terphenyl group are mentioned. Note that the terminals of each of those ring units may have a substituent such as a cyano group, an alkyl group, an alkoxy group, or a halogen group, for example. Of those, for the mesogenic group including a ring unit, a mesogenic group having a biphenyl group or a phenylbenzoate group is preferably used.

As the liquid crystal compound, a compound having at least one polymerizable functional group in a part of the molecule is preferably used. Examples of the polymerizable functional group include an acryloyl group, a methacryloyl group, an epoxy group, and a vinyl ether group. Of those, an acryloyl group and a methacryloyl group are preferably used. Further, it is preferred that the liquid crystal compound have at least two polymerizable functional groups in a part of the molecule. This is because the cross-linked structure formed by a polymerization reaction can enhance durability. Specific examples of the liquid crystal compound having two polymerizable functional groups in a part of the molecule include “PaliocolorLC242” (trade name) manufactured by BASF.

Further, as a retardation film used in the second retardation layer, a solidified layer or a cured layer obtained by homeotropically aligning a liquid crystal composition containing a liquid crystal compound described in JP 2002-174725 A is more preferred. Particularly preferred is a solidified layer or a cured layer obtained by homeotropically aligning a liquid crystal composition containing a liquid crystal polymer represented by the following General Formula (1) as a liquid crystal compound. Most preferred is a cured layer obtained by homeotropically aligning a liquid crystal composition containing a liquid crystal polymer represented by the following General Formula (1) and a liquid crystal compound having at least one polymerizable functional group in a part of the molecule. With such a liquid crystal composition, a retardation film having excellent optical uniformity and high transparency can be obtained.

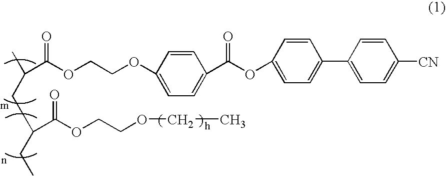

In the formula, h represents an integer of 14 to 20, and assuming that the sum of m and n is 100, m represents 50 to 70 and n represents 30 to 50.

As a method of obtaining a solidified layer or a cured layer of a liquid crystal composition aligned homeotropically, there is a method, for example, of applying a melted material or a solution of the liquid crystal composition to a base material subjected to alignment treatment. Preferably, there is a method of applying a solution (which may also be referred to as an application solution) obtained by dissolving the liquid crystal composition in a solvent to a base material subjected to alignment treatment. According to the above method, a retardation film with less alignment defects (which may also be referred to as discrination) of a liquid crystal composition can be obtained.

A total solid content of the application solution varies depending upon solubility, application viscosity, wettability with respect to a base material, the thickness after application, and the like. In general, a solid content is 2 to 100 (parts by weight), more preferably 10 to 50 (parts by weight), and particularly preferably 20 to 40 (parts by weight) with respect to 100 parts by weight of a solvent. If the solid content is in the above range, a retardation film with high surface uniformity can be obtained. As the solvent, a liquid material capable of dissolving a liquid crystal composition uniformly to form a solution is preferably used.

As the base material, a glass base material such as a glass plate and a quartz substrate, a polymer base material such as a film and a plastic substrate, a metal base material of aluminum or iron, an inorganic base material such as a ceramic substrate, a semiconductor base material such as a silicone wafer, and the like are used and are not particularly limited. A polymer base material is particularly preferred. This is because the polymer base material is excellent in smoothness of the surface and wettability of a liquid crystal composition, and can be produced continuously with rollers, thus enabling the great enhancement of the productivity.

In one embodiment, the base material may be a retardation film having a refractive index profile of nx>ny=nz. In this case, the base material also functions as the first retardation layer, so the reduction in thickness of a laminate is realized, which can contribute to the reduction in thickness of the liquid crystal panel.

As the alignment treatment, any suitable treatment can be selected appropriately depending upon the kind of a liquid crystal compound, the kind of a base material, and the like. Specific examples of the treatment include (A) base material surface direct alignment treatment method, (B) base material surface indirect alignment treatment method, and (C) base material surface deformation alignment treatment method. In the present invention, among them, (A) “base material surface direct alignment treatment method” is preferably used. This is because this treatment is excellent in the ability of aligning liquid crystal compound, which results in a retardation film having excellent optical uniformity and high transparency. In the specification of the present invention, (A) “base material surface direct alignment treatment method” refers to a method of forming an alignment agent in a thin film shape on the surface of a base material by solution application (wet treatment), or plasma polymerization or sputtering (dry treatment), and aligning the alignment azimuth of a liquid crystal compound constantly, using the interaction between the alignment agent and the liquid crystal compound.

Specific examples of the alignment agent to be applied as a solution to the surface of a base material include lecithin, stearic acid, hexadecyltrimethylammonium bromide, octadecylaminehydrochloride, a monobasic carboxylic acid-chrome complex (e.g., a myristic acid-chrome complex, a perfluorononic acid-chrome complex, etc.), and organic silane (e.g., a silane coupling agent, siloxane, etc.). Further, specific examples of the alignment agent to be plasma-polymerized on the surface of a base material include perfluorodimethylcyclohexane and tetra fluoroethylene. Further, a specific example of the alignment agent to be sputtered on the surface of a base material includes polytetra fluoroethylene. As the alignment agent, organic silane is particularly preferred. This is because organic silane is excellent in workability, the quality of a product, and the alignment property of a liquid crystal compound. A specific example of the alignment agent of organic silane includes an alignment agent (“Ethylsilicate” (trade name) manufactured by COLCOAT Co., Ltd.) containing tetraethoxysilane as a main component.

A method of applying the application solution to a base material is not particularly limited, and an application method using any suitable coater can be used.

As a method of fixing a liquid crystal composition aligned homeotropically, any of a solidifying method and/or a curing method can be adopted depending upon the kind of a liquid crystal compound to be used. For example, in the case where a liquid crystal composition contains a liquid crystal polymer as a liquid crystal compound, practically sufficient mechanical strength can be obtained by solidifying a melted material or a solution containing the liquid crystal polymer. On the other hand, in the case where a liquid crystal composition contains a liquid crystal monomer as a liquid crystal compound, mechanical strength may not be obtained sufficiently merely by solidifying a solution of the liquid crystal monomer. In such a case, by using a polymerizable liquid crystal monomer having at least one polymerizable functional group in a part of the molecule, and curing the polymerizable liquid crystal monomer by irradiation of UV, practically sufficient mechanical strength can be obtained. In the present invention, a base material with an application solution applied thereto may be subjected to a drying treatment before and/or after the irradiation of UV. The drying temperature is preferably 50° C. to 130° C., and more preferably 80° C. to 100° C. The drying time is, for example, 1 to 20 minutes, preferably 1 to 15 minutes, and more preferably 2 to 10 minutes. By setting the drying temperature and the drying time in the above range, a retardation film having satisfactory optical uniformity can be obtained.

The thickness of the retardation film can be selected appropriately depending upon the purpose. The thickness is preferably 0.1 μm to 100 μm, more preferably 0.1 μm to 80 μm, and particularly preferably 0.1 μm to 50 μm. If the thickness is in the above range, a retardation film having excellent mechanical strength and display uniformity can be obtained.

### D. Adhesion Enhancement Layer

The adhesion enhancement layer contains a polyethyleneimine as a main component. The polyethyleneimine has a primary amino group at a terminal and a secondary amino group in a principal chain, and has a large ratio of amino groups in the resin, thereby the adhesion enhancement layer and a pressure-sensitive adhesive layer can be strongly bonded to each other resulted from a reaction of amino groups of polyethyleneimine and functional groups of the pressure-sensitive adhesive layer at an interface between the adhesion enhancement layer and the pressure-sensitive adhesive layer and in the vicinity thereof. Polyethyleneimine is soluble in water/alcohol, and can prevent the material of the adhesion enhancement layer from being degraded even if the material is inferior in solvent durability.

In the present invention, any appropriate polyethyleneimine can be used. The weight average molecular weight of polyethyleneimine is preferably 100 to 1,000,000. Examples of a commercially available product of polyethyleneimine include Epomine SP series (SP-003, SP006, SP012, SP018, SP103, SP110, SP200, etc.), and Epomine P-1000, produced by Nippon Shokubai Co., Ltd. Of those, Epomine P-1000 is preferred.

The thickness of the adhesion enhancement layer is preferably 1 nm to 30 nm, more preferably 2 nm to 20 nm, and particularly preferably 3 nm to 15 nm.

In formation of an adhesion enhancement layer, polyethyleneimine and a compound that reacts with polyethyleneimine are mixed to be cross-linked, which can enhance the strength of the adhesion enhancement layer. As a compound that reacts with polyethyleneimine, an epoxy compound or the like can be exemplified.

Polyethyleneimine for forming the adhesion enhancement layer has a primary amino group at a terminal, and on the other hand, a base polymer containing a functional group that reacts with an amino group is used for a pressure-sensitive adhesive forming a pressure-sensitive adhesive layer described later. Therefore, the amino group and the base polymer functional group react with each other at an interface between the adhesion enhancement layer and the pressure-sensitive adhesive layer and in the vicinity thereof. Consequently, in a region where the amino group in the adhesion enhancement layer and the functional group in the pressure-sensitive adhesive layer react with each other, a mixed reaction layer in which polyethyleneimine and a base polymer are interpenetrated into each other is formed, whereby the adhesion enhancement layer and the pressure-sensitive adhesive layer are strongly bonded to each other. Thus, the adhesive strength (anchoring force) between the second retardation layer and the pressure-sensitive adhesive layer increases remarkably. As a result, an adhesive residue at the time of reworking can be prevented satisfactorily.

On the other hand, a portion of the adhesion enhancement layer, which is not to be the mixed reaction layer, does not participate in the above reaction. Therefore, that portion does not contribute to the bonding, and may rather decrease the bonding property when its ratio increases. Based on such finding, the thickness of the mixed reaction layer is adjusted to be preferably 50% or more and more preferably 80% or more of the entire thickness of the adhesion enhancement layer. The mixed reaction layer can be recognized as a strongly dyed layer when an optical film is dyed with ruthenic acid. Thus, in a portion of the adhesion enhancement layer, which is unlikely to be dyed with ruthenic acid, polyethyleneimine is present alone.

### E. Pressure-Sensitive Adhesive Layer

As a pressure-sensitive adhesive forming the pressure-sensitive adhesive layer, various kinds of pressure-sensitive adhesives such as a rubber-based pressure-sensitive adhesive, an acrylic pressure-sensitive adhesive, and a silicone-based pressure-sensitive adhesive can be used without any particular limit. However, a color less and transparent acrylic pressure-sensitive adhesive having a satisfactory adhesive property with respect to a liquid crystal cell and the like is preferred. Further, it is preferred that a base polymer of the pressure-sensitive adhesive have a functional group reacting with an amino group.

The acrylic pressure-sensitive adhesive contains, as a base polymer, an acrylic polymer having a monomer unit of alkyl(meth)acrylate as a main skeleton. (Meth)acrylate refers to acrylate and/or methacrylate.

As the base polymer, it is preferred to use a polymer containing a functional group that reacts with an amino group. With the use of such a base polymer, the amino group of polyethyleneimine and the functional group in the pressure-sensitive adhesive layer react with each other at an interface between the adhesion enhancement layer and the pressure-sensitive adhesive layer and in the vicinity thereof, whereby the adhesion enhancement layer and the pressure-sensitive adhesive layer are strongly bonded to each other. Examples of the functional group that reacts with the amino group include a carboxyl group, an epoxy group, and an isocyanate group. Of those, the carboxyl group is preferred. The carboxyl group is preferred as a functional group contained in a base polymer due to the satisfactory reactivity with the amino group, and makes the bonding between the pressure-sensitive adhesive layer and the adhesion enhancement layer satisfactory. An acrylic polymer having a functional group that reacts with an amino group contains a monomer unit having the functional group. Examples of a monomer having a carboxyl group include acrylic acid, methacrylic acid, fumaric acid, maleic acid, and itaconic acid. An example of the monomer containing an epoxy group includes glycidyl(meth)acrylate.

The thickness of the pressure-sensitive adhesive layer is preferably 1 μm to 100 μm, more preferably 5 μm to 80 μm, and particularly preferably 10 μm to 50 μm.

### F. Adhesive Layer

As an adhesive forming an adhesive layer, typically, there is a curable adhesive. Representative examples of the curable adhesive include a photocurable adhesive such as a UV-curable adhesive, a moisture-curable adhesive, and a heat-curable adhesive.

The application amount of an adhesive between the respective layers can be set appropriately depending upon the purpose. For example, the application amount is preferably 0.3 ml to 3 ml, more preferably 0.5 ml to 2 ml, and still more preferably 1 ml to 2 ml per area (cm²) with respect to a principal plane of each layer.

After application, if required, a solvent contained in the adhesive is volatilized by natural drying or heat drying. The thickness of the adhesive layer thus obtained is preferably 0.1 μm to 20 μm, more preferably 0.5 μm to 15 μm, and still more preferably 1 μm to 10 μm.

### G. Polarizer

As described above, the optical laminate of the present invention may have a polarizer on the side of the first retardation film on which the second retardation film is not provided. Any appropriate polarizer may be employed as the polarizer used in the present invention in accordance with the purpose. Examples thereof include: a film obtained by adsorbing a dichromatic substance such as iodine or a dichromatic dye on a hydrophilic polymer film such as a polyvinyl alcohol-based film, a partially formalized polyvinyl alcohol-based film, or a partially saponified ethylene/vinyl acetate copolymer-based film and uniaxially stretching the film; and a polyene-based aligned film such as a dehydrated product of a polyvinyl alcohol-based film or a dehydrochlorinated product of a polyvinyl chloride-based film. Of those, a polarizer obtained by adsorbing a dichromatic substance such as iodine on a polyvinyl alcohol-based film and uniaxially stretching the film is particularly preferable because of high-polarized dichromaticity.

The polarizer obtained by adsorbing iodine on a polyvinyl alcohol-based film and uniaxially stretching the film may be produced by, for example: immersing a polyvinyl alcohol-based film in an aqueous solution of iodine for coloring; and stretching the film to 3 to 7 times length of the original length. The aqueous solution may contain boric acid, zinc sulfate, zinc chloride, or the like as required, or the polyvinyl alcohol-based film may be immersed in an aqueous solution of potassium iodide or the like. Further, the polyvinyl alcohol-based film may be immersed and washed in water before coloring as required.

As the thickness of the polarizer, any suitable thickness can be adopted. The thickness of the polarizer is typically 5 μm to 80 μm, more preferably 10 μm to 50 μm, and still more preferably 20 μm to 40 μm. If the polarizer has a thickness in the above range, excellent optical properties and mechanical strength can be obtained.

The polarizer is placed so that its absorption axis is substantially perpendicular to the slow axis of the first retardation layer. The phrase “substantially perpendicular” includes the case where an angle formed by two directions (herein, an angle formed by the absorption axis of the polarizer and the slow axis of the first retardation layer) is 90°±2.0°, more preferably 90°±1.0°, and still more preferably 90°±0.5°. As the angle departs from those ranges, a contrast tends to decrease when such a polarizer is used in a liquid crystal display apparatus.

Practically, any suitable protective layer is provided on the side of the polarizer opposite to the first retardation layer 10. Any suitable protective layer may be provided between the polarizer and the first retardation layer 10.

### H. Liquid Crystal Panel

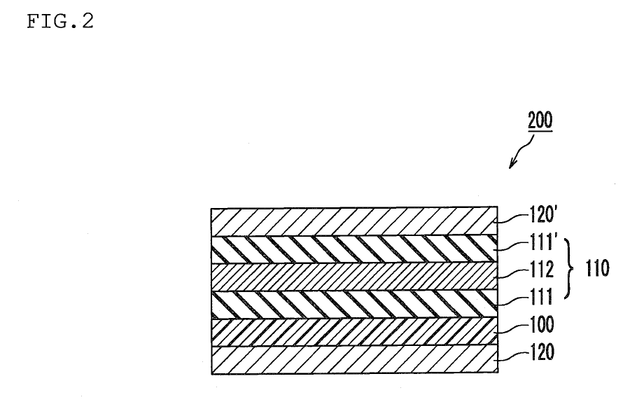

FIG. 2 is a schematic cross-sectional view of a liquid crystal panel according to a preferred embodiment of the present invention. A liquid crystal panel 200 includes a liquid crystal cell 110, an optical laminate 100 placed on one side (a backlight side in the illustrated example) of the liquid crystal cell 110, a polarizer 120 placed on an outer side of the optical laminate 100, and a polarizer 120′ placed on the other side (a viewer side in the illustrated example) of the liquid crystal cell 110. The optical laminate 100 is the optical laminate of the present invention. The optical laminate 100 is attached to the liquid crystal cell 110 via a pressure-sensitive adhesive layer 40 so that a second retardation layer 20 is placed on the liquid crystal cell side. In the case where the optical laminate 100 has a polarizer, the polarizer 120 is omitted. Any suitable retardation layer (not shown) may be placed between the liquid crystal cell 110 and the polarizer 120′ depending upon the purpose. The polarizers 120 and 120′ are typically placed so that the absorption axes thereof are substantially perpendicular to each other. The liquid crystal cell 110 includes: a pair of glass substrates 111 and 111′; and a liquid crystal layer 112 as a display medium arranged between the substrates. One substrate (active matrix substrate) 111 is provided with: a switching element (typically, TFT) for controlling electrooptic characteristics of liquid crystal; and a scanning line for providing a gate signal to the switching element and a signal line for providing a source signal thereto (the element and the lines not shown). The other glass substrate (color filter substrate) 111′ is provided with a color filter (not shown). The color filter may be provided on the active matrix substrate 111. A space (cell gap) between the substrates 111 and 111′ is controlled by a spacer (not shown). An alignment film (not shown) formed of, for example, polyimide is provided on a side of each of the substrates 111 and 111′ in contact with the liquid crystal layer 112.

### EXAMPLES

Hereinafter, the present invention will be described specifically by way of examples. It should be noted that the present invention is not limited to these examples. An evaluation method in the examples is as follows.

### (Thickness Direction Retardation Change Amount)

An optical laminate was produced and placed under environments: temperature of 80° C., and temperature of 60° C. and humidity of 90%, and a change in a thickness direction retardation after the elapse of 400 hours was measured using “KOBRA 21-ADH” (trade name) manufactured by Oji Scientific Instruments.

### (Anchoring Force)

A pressure-sensitive adhesive surface of a film with a length of 10 cm and a width of 25 mm was attached to ITO-deposited PET, and the film was peeled at a rate of 300 mm/min and a peel angle of 180°, to determine the anchoring force thereof, by using “AUTOGRAPH AG-1” (trade name) manufactured by Shimadzu Corporation.

### Reference Example 1

Production of a retardation film A having a refractive index profile of nx>ny=nz

A commercially available polymer film (“Zeonor ZF14-100” (tradename) thickness: 100 μm, glass transition temperature: 171° C., weight average molecular weight: 130,000, manufactured by Zeon Corporation), containing polynorbornene as a main component, was longitudinally uniaxially stretched 3 times with a roll stretching machine in an air-circulating thermostatic oven at 150° C. (the temperature was measured at a distance of 3 cm from the reverse surface of the film, and a temperature variation of ±1° C.) while a longer side of the film was held, whereby a retardation film A was produced. The thickness of the film was 30 μm, and the in-plane retardation Re[590] thereof was 120 nm.

### Reference Example 2

Production of a retardation film B having a refractive index profile of nz>nx=ny

The following were mixed to prepare a liquid crystal composition: 4 parts by weight of a liquid crystal polymer (weight average molecular weight: 5,000) represented by the following Expression (2); 16 parts by weight of a commercially available liquid crystal compound (“PaliocolorLC242” (trade name) manufactured by BASF) having a phenylbenzoate group as a mesogen group, and having two polymerizable functional groups in a molecular structure; 1 part by weight of a photopolymerization initiator (“IRGACURE 127” (trade name) manufactured by Ciba Specialty Chemicals Inc.); and 0.05 part by weight of a leveling agent (“BYK-370” (trade name) manufactured by BYK). The obtained liquid crystal composition was mixed with 79 parts by weight of cyclopentanone to be dissolved therein, whereby an application solution was produced.

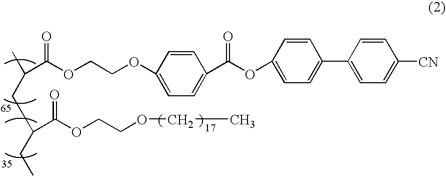

The application solution was applied to a base material film having thickness of 100 μm (“Zeonor ZF14-100” (trade name) manufactured by Zeon Corporation) with a bar coater (“Mayer rot HS1.5#4” (tradename) manufactured by BUSCHMAN), dried for 3 minutes in an air-circulating oven at 80° C., and cured by the irradiation of UV at 400 mJ/cm² with a UV irradiating machine (“UVC-321AM1” (trade name) manufactured by Ushio Inc.) while the film was being transported at a rate of 2.7 cm/min, whereby a retardation film B was obtained. The thickness of the film was 1.1 μm, and the in-plane retardation Re[590] thereof was 1 nm.

### Production of Optical Laminate

### Example 1

The retardation film B was subjected to a corona treatment under the condition of 116 W/m²·min using a batch corona treatment machine (“CORONA GENERATOR CT-0212” (trade name) manufactured by Kasuga Denki Inc.).

“Hydland 920” manufactured by Dainippon Ink and Chemicals, Incorporated, with a solid content of 40%, was applied to the retardation film B (second retardation layer) subjected to the corona treatment, and dried for 3 minutes in an air-circulating oven at 80° C., whereby an adhesive layer with a thickness of 5 μm was formed. The retardation film A (Re[590]=120 nm, Nz coefficient=1.35) produced in Reference Example 1 was laminated on the formed adhesive layer, and the base material was peeled, whereby a first retardation layer was formed. After peeling, the side of the second retardation layer where the first retardation layer was not formed was subjected to a corona treatment similar to the above, a polyethyleneimine composition (“Epomine P-1000” (trade name) manufactured by Nippon Shokubai Co., Ltd.) was applied to the corona-treated surface to a thickness of 4 μm, using a bar coater (“Mayer rot HS 1.5#5” (trade name) manufactured by BUSCHMAN), and treated at 80° C. for 3 minutes, whereby an adhesion enhancement layer was formed. The thickness of the adhesion enhancement layer was 30 nm. After that, an acrylic pressure-sensitive adhesive layer of 23 μm was formed on the adhesion enhancement layer to obtain an optical laminate. The obtained optical laminate was measured for a thickness retardation change amount and an anchoring force by the above method. The obtained properties are as shown in Table 1.

### Comparative Example 1

An optical laminate was produced in the same way as in Example 1, except that the corona treatment was not conducted, and the adhesion enhancement layer was not provided. The optical laminate thus produced was evaluated in the same way as in Example 1. Table 1 shows the properties of the obtained optical laminate.

### Comparative Example 2

An optical laminate was produced in the same way as in Example 1, except that the adhesion enhancement layer was not provided. The optical laminate thus produced was evaluated in the same way as in Example 1. Table 1 shows the properties of the obtained optical laminate.

### Comparative Example 3

An optical laminate was produced in the same way as in Example 1, except that the adhesion enhancement layer was formed using a silicone-based primer ((HO)₃Si(CH₂)₃NH(CH)₂NH₂ “APZ6601” (trade name) manufactured by Dow Corning Toray Co., Ltd.) instead of polyethyleneimine “Epomine P-1000”. The optical laminate thus produced was evaluated in the same way as in Example 1. Table 1 shows the properties of the obtained optical laminate.

TABLE 1

| | |
|---|---|
| Thickness retardation | |
| change amount (nm) | Anchoring force |

| | 80° C. | 60° C./90% | (N/25 mm) |
|---|---|---|---|
| Example 1 | 4 | 1 | 35 |
| Comparative | 6 | 3 | 2 |
| Example 1 | | | |
| Comparative | 8.5 | 6 | 12 |
| Example 2 | | | |
| Comparative | 6 | 2 | 12 |
| Example 3 | | | |

It is understood from Table 1 that the thickness retardation change amount at a temperature of 80° C. is satisfactory in Example 1, and is not preferred practically in Comparative Examples 1 to 3. It is also understood that the thickness retardation change amount at a temperature of 60° C. and a humidity of 90% is significantly satisfactory in Example 1, is satisfactory in Comparative Example 3, is practically acceptable in Comparative Example 1, and is not practically preferred in Comparative Example 2. Further, it is understood that the anchoring force is remarkably excellent in Example 1, compared with those in Comparative Examples 1 to 3. Thus, it is understood that the optical laminate of the present invention is excellent in adhesive strength (anchoring force) between the second retardation layer having a refractive index profile of nz>nx=ny and the pressure-sensitive adhesive layer, and can suppress change in a retardation value under high temperature and high humidity.

The optical laminate of the present invention is used preferably for a liquid crystal display apparatus and a liquid crystal television.

Many other modifications will be apparent to and be readily practiced by those skilled in the art without departing from the scope and spirit of the invention. It should therefore be understood that the scope of the appended claims is not intended to be limited by the details of the description but should rather be broadly construed.

What is claimed is:

1. An optical laminate, comprising:
a first retardation layer having a refractive index profile of nx>ny=nz;
a second retardation layer having a refractive index profile of nz>nx=ny; and
an adhesion enhancement layer containing polyethyleneimine as a main component in the state order.

2. An optical laminate according to claim 1, wherein the first retardation layer functions as a base material.

3. An optical laminate according to claim 1, wherein the first retardation layer comprises a stretched film of a polymer film containing polynorbornene as a main component.

4. An optical laminate according to claim 1, wherein the first retardation layer comprises a stretched film of a polymer film containing polycarbonate as a main component.

5. An optical laminate according to claim 1, wherein the first retardation layer has an in-plane retardation value (Re[590]) of 50 nm to 180 nm measured with light having a wavelength of 590 nm at 23° C.

6. An optical laminate according to claim 1, wherein the first retardation layer has a thickness of 10 μm to 500 μm.

7. An optical laminate according to claim 1, wherein the second retardation layer is placed on the first retardation layer via an adhesive layer.

8. An optical laminate according to claim 1, wherein the second retardation layer is directly placed on the first retardation layer.

9. An optical laminate according to claim 1, wherein the second retardation layer has a thickness direction retardation value (Rth[590]) of −200 nm to −30 nm measured with light having a wavelength of 590 nm at 23° C.

10. An optical laminate according to claim 1, wherein the second retardation layer comprises one of a solidified layer and a cured layer of a liquid crystal composition aligned homeotropically.

11. An optical laminate according to claim 10, wherein a content of a liquid crystal compound in the liquid crystal composition is 40 to 100 (weight ratio) with respect to a total solid content of 100.

12. An optical laminate according to claim 1, wherein the adhesion enhancement layer has a thickness of 1 nm to 30 nm.

13. An optical laminate according to claim 1, wherein the polyethyleneimine has a weight average molecular weight of 100 to 1,000,000.

14. An optical laminate according to claim 1, wherein the polyethyleneimine has a primary amino group at a terminal.

15. An optical laminate according to claim 1, further comprising a pressure-sensitive adhesive layer on the side of the adhesion enhancement layer on which the second retardation layer is not provided.

16. An optical laminate according to claim 1, further comprising a polarizer on the side of the first retardation layer on which the second retardation layer is not provided.

17. A liquid crystal panel, comprising:
a liquid crystal cell; and
the optical laminate according to claim 1.
